(19) United States
(12) Patent Application Publication
(10) Pub. No.: US 2026/0086215 A1
(43) Pub. Date: Mar. 26, 2026

(54) SYSTEM AND METHOD FOR ALERT DEVICE

(71) Applicant: Purdue Research Foundation, West Lafayette, IN (US)

(72) Inventors: Elizabeth Grace Colip, Downers Grove, IL (US); Michael Franklin Brown, Franklin, TN (US); Audrey Elizabeth Darland, Carmel, IN (US); Cameron Elshad Garayev, Aurora, IL (US); Claire Elizabeth Taranowski, Libertyville, IL (US)

(73) Assignee: Purdue Research Foundation, West Lafayette, IN (US)

(21) Appl. No.: 19/311,749

(22) Filed: Aug. 27, 2025

Related U.S. Application Data
(60) Provisional application No. 63/698,139, filed on Sep. 24, 2024.

(51) Int. Cl. G01S 7/521; E04H 4/06; G01S 15/08; G08B 3/10; G08B 21/08; G09B 21/00

(52) U.S. Cl. CPC G01S 7/521; E04H 4/06; G01S 15/08; G08B 3/10; G08B 21/08; G09B 21/006

(57) ABSTRACT

The alert system includes a sensor, a sensor panel, a speaker, and a housing. The sensor and/or the speaker may be coupled to the sensor panel. The sensor panel may be coupled housing. The sensor panel may include a buoyant portion having a density less than the density of water. The alert system may also include a track system that permits the sensor panel to travel along a length of the track system. For instance, the sensor panel may travel vertically along the housing's track system allowing the sensor panel to be disposed in and/or on the water surface of the pool. The sensor may detect a distance between a user and the sensor. The speaker emits an audible tone once the user is detected within a predetermined distance threshold of the sensor.

### CROSS REFERENCE TO RELATED APPLICATIONS

This application claims the benefit of U.S. Provisional Application No. 63/698,139 filed Sep. 24, 2024, the entirety of which is hereby incorporated by reference.

### FIELD

The disclosure generally relates to sensor systems and, more particularly, to sensor systems for persons with physical impairments.

### INTRODUCTION

This section provides background information related to the present disclosure which is not necessarily prior art.

Physical activity is widely acknowledged as a vital component of overall health, well-being, and social interaction for many individuals. Yet, for individuals with visual impairments, the barriers to participating in sports are often significant due to decreased levels of independence. One of the most prominent methods of exercise for the blind is swimming. However, the risks associated with swimming, specifically the potential for collisions with the pool walls and lane lines, make the idea of swimming independently seem daunting for those with limited vision. These fears exist not only for those just learning to swim, but also for Paralympic-level swimmers.

One known method for wall detection in swimming involves the use of human tappers positioned on either end of the lane. These tappers tap the swimmer on the head with an object to signal when to begin the flip turn. Remarkably, these devices used to tap the swimmer are not available commercially. All swimmers, Paralympians included, have to create one themselves. Additionally, tappers are costly and perform inconsistently. Historically, tappers have failed to tap swimmers in time, resulting in injury.

Another known wall detection system includes devices with cameras and sensors that communicate via Bluetooth. However, Bluetooth technology has been found to be unreliable to communicate underwater.

Accordingly, there is a continuing need for a sensor-based solution that may alert a user of upcoming walls without human interaction.

### SUMMARY

In concordance with the instant disclosure, a sensor-based alert system for notifying a swimmer of location of a wall of a pool, has surprisingly been discovered.

The alert system of the present disclosure includes a sensor, a sensor panel, a speaker, and a housing. The housing may be selectively coupled to a surface, such as a wall of a pool. The sensor may include an ultrasonic sensor. In a specific example, the sensor may include a plurality of sensors. The sensor(s) and/or the speaker may be coupled to the sensor panel. The sensor panel may be coupled to the housing. In an alternative example, the speaker may be coupled to the housing. The sensor panel may include a buoyant portion. The buoyant portion may have a density less than the density of water. In a specific example, the alert system may include a track system that permits the buoyant sensor panel to travel along a length of the track system. For instance, the buoyant sensor panel may travel vertically along the housing's track system allowing the buoyant sensor panel to be disposed in and/or on the water surface of the pool. This may allow the alert system to be easily utilized in different pools with varying distances between the surface of the water and the edge of the pool. The sensor may detect a distance between a user and the sensor. The speaker emits an audible tone once the user is detected within a predetermined distance threshold of the sensor.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a top perspective view of the alert system, further depicting the alert system disposed in an expanded “in-use”position;

FIG. 2 is a top perspective view of the alert system, as shown in FIG. 1, further depicting the alert system disposed in a closed “travel” position, according to one embodiment of the present disclosure;

FIG. 3 is a left-side elevational view of the alert system, as shown in FIG. 2, according to one embodiment of the present disclosure;

FIG. 4 is a front elevational view of the sensor panel of the alert system, according to one embodiment of the present disclosure;

FIG. 5 is an enlarged top perspective view of a hinge on a track system of the alert system, according to one embodiment of the present disclosure;

FIG. 6 is a top perspective view of the interior of the housing having a central housing disposed therein, according to one embodiment of the present disclosure;

FIG. 7 is a top perspective view of the interior of the central housing, according to one embodiment of the present disclosure;

FIG. 8 is a flow chart of a method of using the alert system, according to one embodiment of the present disclosure;

FIG. 9 includes a plot diagram illustrating the sensing uncertainty of the alert system, according to one embodiment of the present disclosure;

FIG. 10 is a schematic diagram of the alert system, further depicting the system having a communication interface, an input interface, a user interface, and a system circuitry, wherein the system circuitry may include a processor and a memory, according to one embodiment of the present disclosure; and

FIG. 11 is a flow chart of a method of using the alert system, according to one embodiment of the present disclosure.

### DETAILED DESCRIPTION

The following description of technology is merely exemplary in nature of the subject matter, manufacture, and use of one or more inventions, and is not intended to limit the scope, application, or uses of any specific invention claimed in this application or in such other applications as may be filed claiming priority to this application, or patents issuing therefrom. Regarding methods disclosed, the order of the steps presented is exemplary in nature, and thus, the order of the steps can be different in various embodiments, including where certain steps can be simultaneously performed. “A” and “an” as used herein indicate “at least one” of the item is present; a plurality of such items may be present, when possible. Except where otherwise expressly indicated, all numerical quantities in this description are to be understood as modified by the word “about” and all geometric and spatial descriptors are to be understood as modified by the word “substantially” in describing the broadest scope of the technology. “About” when applied to numerical values indicates that the calculation or the measurement allows some slight imprecision in the value (with some approach to exactness in the value; approximately or reasonably close to the value; nearly). If, for some reason, the imprecision provided by “about” and/or “substantially” is not otherwise understood in the art with this ordinary meaning, then “about” and/or “substantially” as used herein indicates at least variations that may arise from ordinary methods of measuring or using such parameters.

Although the open-ended term “comprising,” as a synonym of non-restrictive terms such as including, containing, or having, is used herein to describe and claim embodiments of the present technology, embodiments may alternatively be described using more limiting terms such as “consisting of” or “consisting essentially of.” Thus, for any given embodiment reciting materials, components, or process steps, the present technology also specifically includes embodiments consisting of, or consisting essentially of, such materials, components, or process steps excluding additional materials, components or processes (for consisting of) and excluding additional materials, components or processes affecting the significant properties of the embodiment (for consisting essentially of), even though such additional materials, components or processes are not explicitly recited in this application. For example, recitation of a composition or process reciting elements A, B and C specifically envisions embodiments consisting of, and consisting essentially of, A, B and C, excluding an element D that may be recited in the art, even though element D is not explicitly described as being excluded herein.

As referred to herein, disclosures of ranges are, unless specified otherwise, inclusive of endpoints and include all distinct values and further divided ranges within the entire range. Thus, for example, a range of “from A to B” or “from about A to about B” is inclusive of A and of B. Disclosure of values and ranges of values for specific parameters (such as amounts, weight percentages, etc.) are not exclusive of other values and ranges of values useful herein. It is envisioned that two or more specific exemplified values for a given parameter may define endpoints for a range of values that may be claimed for the parameter. For example, if Parameter X is exemplified herein to have value A and also exemplified to have value Z, it is envisioned that Parameter X may have a range of values from about A to about Z. Similarly, it is envisioned that disclosure of two or more ranges of values for a parameter (whether such ranges are nested, overlapping, or distinct) subsume all possible combination of ranges for the value that might be claimed using endpoints of the disclosed ranges. For example, if Parameter X is exemplified herein to have values in the range of 1-10, or 2-9, or 3-8, it is also envisioned that Parameter X may have other ranges of values including 1-9, 1-8, 1-3, 1-2, 2-10, 2-8, 2-3, 3-10, 3-9, and so on.

When an element or layer is referred to as being “on,” “engaged to,” “connected to,” or “coupled to” another element or layer, it may be directly on, engaged, connected, or coupled to the other element or layer, or intervening elements or layers may be present. In contrast, when an element is referred to as being “directly on,” “directly engaged to,” “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the FIG. is turned over, elements described as “below”, or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

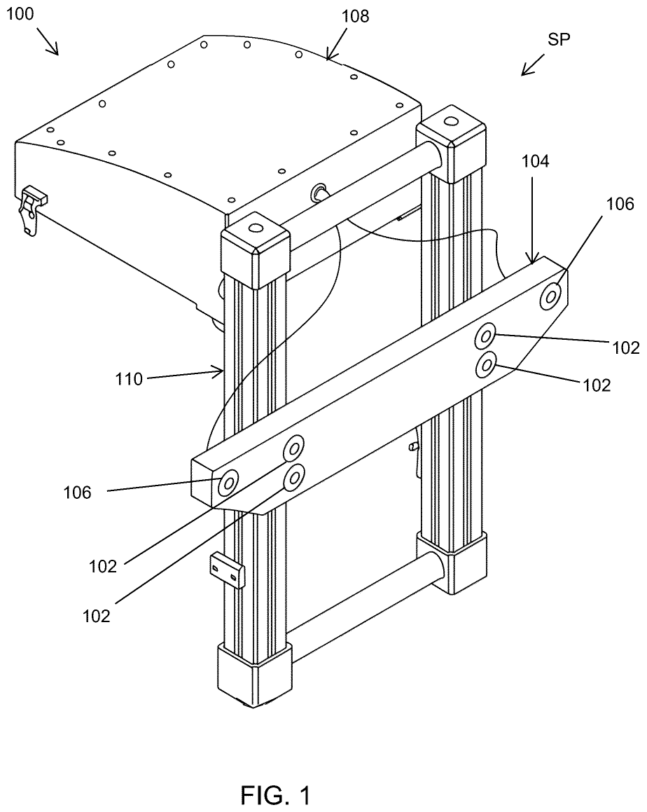

As shown in FIG. 1, the alert system 100 of the present disclosure includes a sensor 102, a sensor panel 104, a speaker 106, and a housing 108. The housing 108 may be selectively coupled to a surface, such as a wall of a pool. The sensor 102 may include an ultrasonic sensor. In a specific example, the sensor 102 may include a plurality of sensors. In another specific example, the speaker 106 may include a plurality of speakers. In a more specific example, the speaker 106 may include a piezo buzzer. Each of the sensor(s) 102, the speaker(s) 106, and the housing 108 may be water-resistant, waterproof, or otherwise militate against water damage. The sensor(s) 102 and/or the speaker(s) 106 may be coupled to the sensor panel 104. The sensor panel 104 may be coupled to the housing 108. In a specific example, the alert system 100 may include a track system 110 that couples the sensor panel 104 to the housing 108. The track system 110 may permit the sensor panel 104 to travel along a length of the track system 110. For instance, the sensor panel 104 may travel vertically along the track system 110. The sensor panel 104 may include a buoyant portion having a density less than the density of water. The vertical travel of the buoyant sensor panel 104 along the track system 110 may allow the buoyant sensor panel 104 to be disposed in and/or on the water surface of the pool. This may allow the alert system 100 to be easily utilized in different pools with varying distances between the surface of the water and the edge of the pool. The ends of the track system 110 may be capped to militate against the sensor panel 104 from becoming detached from the track system 110. One skilled in the art may select other suitable ways to provide the alert system 100, within the scope of the present disclosure.

The sensor 102 may be used in various ways. For instance, the sensor 102 may be controlled by a processor 112. The processor 112 may include instructions to continuously acquire a distance measurement from the sensor 102 and activate the speaker 106 when the measured distance is less than a predetermined detection range. Provided as a non-limiting example, the predetermined detection range may be from around forty centimeters to around two meters. In certain circumstances, the predetermined detection range may be adjusted by a user to their preference. One skilled in the art may select other suitable ways for using the sensor 102, within the scope of the present disclosure.

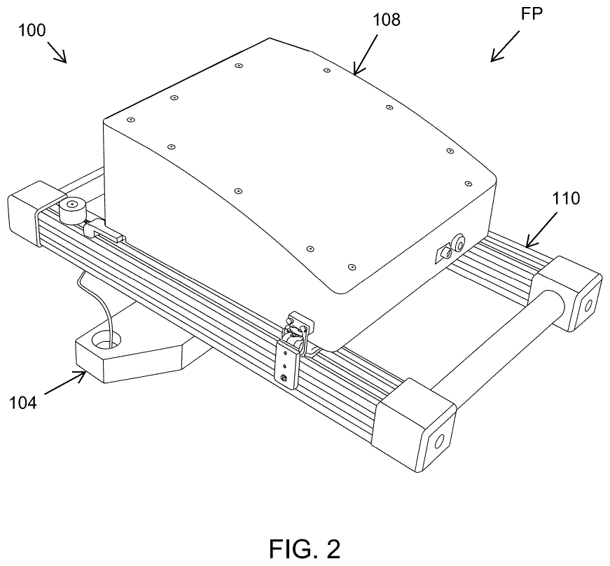

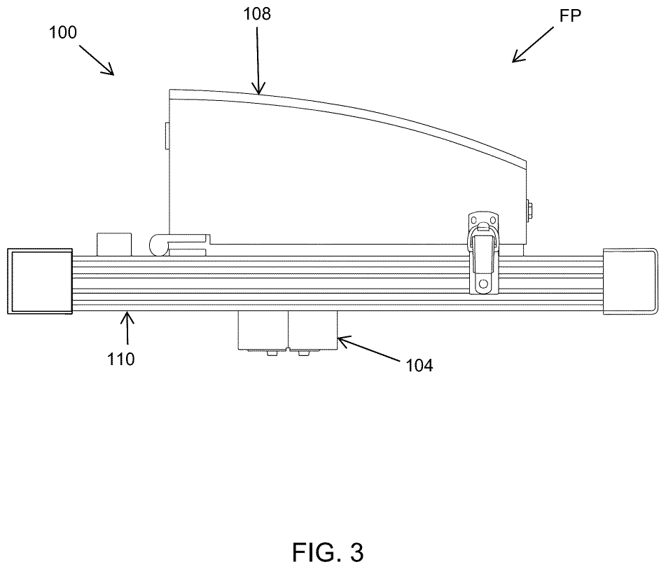

In certain circumstances, the alert system 100 may be selectively moved between a first position FP and a second position SP. For instance, as shown in FIGS. 2 and 3, the first position FP may be a compact position for easier transport, and the second position SP may be an extended position for utilization in a pool, as shown in FIG. 1. More specifically, the alert system 100 may include a hinge 114 that selectively permits the track system 110 to fold between the first position FP and the second position SP. In another specific example, the alert system 100 may include latch and/or locking mechanism to retain the alert system 100 in either the first position FP or the second position SP.

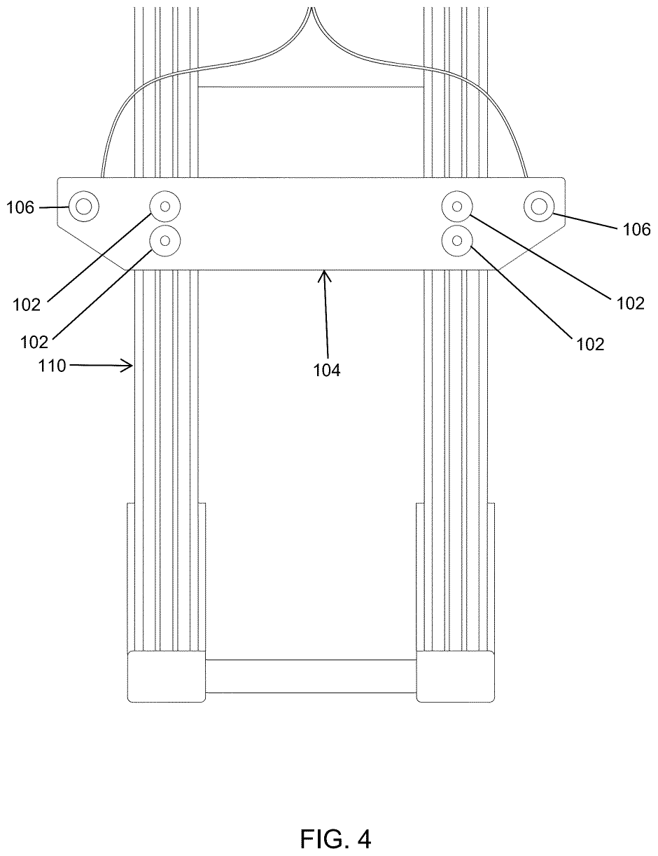

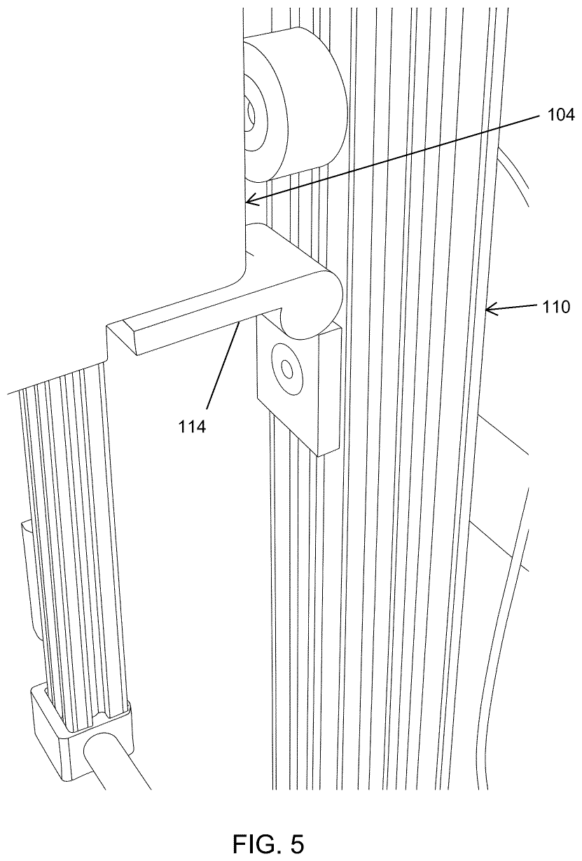

The buoyant sensor panel 104 may be provided in various ways. For instance, the buoyant sensor panel 104 may be constructed from a foam material. Provided as a non-limiting example, the foam material may include Ethylene-vinyl acetate (EVA) foam. It is contemplated that other low-density foam materials may also be utilized for the buoyant sensor panel 104. Advantageously, the buoyancy of the buoyant sensor panel 104 may allow for the sensor(s) 102 and/or the speaker(s) 106 to be consistently disposed at a substantially repeatable position based on the water surface in different pools. For instance, as shown in FIGS. 4-5, the buoyant sensor panel 104 may freely travel along the length of the track system 110 to routinely position the sensor(s) 102 and/or the speaker(s) 106 at and/or below the water surface of the pool. In a specific example, the track system 110 may include a t-slotted framing bar, which enables vertical repositioning of the sensor panel 104 relative to a pool wall. One skilled in the art may select other suitable materials for providing the buoyancy of the buoyant sensor panel 104, within the scope of the present disclosure.

In certain circumstances, the accuracy of the alert system 100 may be enhanced. For instance, the sensors 102 may be configured to capture the largest range of motion of the user. More specifically, the plurality of sensors 102 may be spaced apart so that the placement is optimized for the peripheral vision of the plurality of sensors to capture the largest range of motion. In a more specific example, the sensors 102 may be spaced apart by at least around twelve inches. Provided as a non-limiting example, the sensors 102 may be placed up to around eighteen inches apart from one another to capture a larger range of motion. It is also contemplated that one skilled in the art may select other sensors 102 that may be utilized with the alert system 100, which may have a different optimized spacing to capture the largest range of motion. A skilled artisan may select other suitable ways for enhancing the accuracy of the alert system 100, within the scope of the present disclosure.

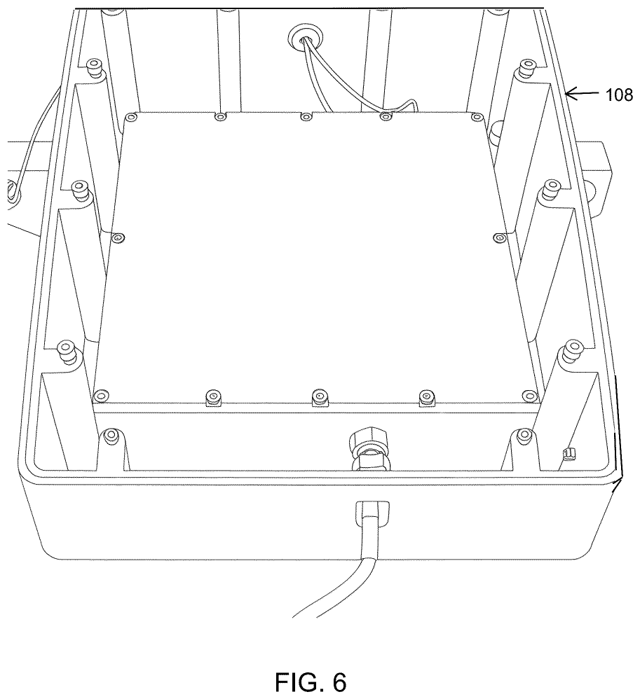

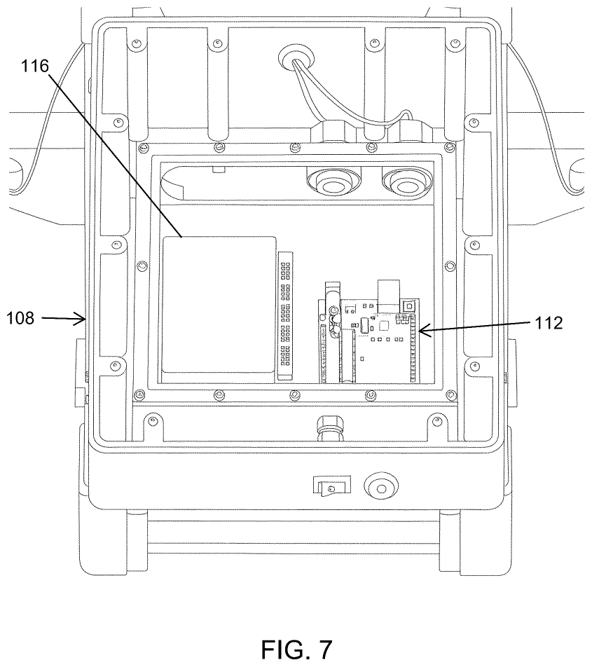

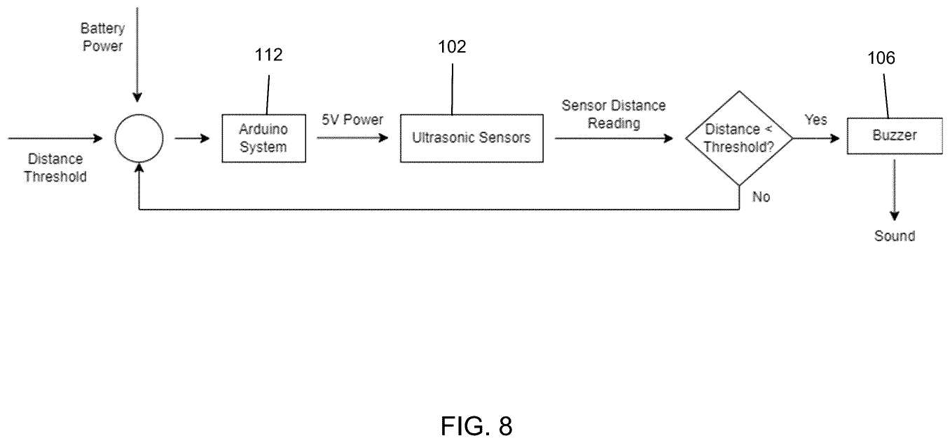

The housing 108 may be provided in various ways. For instance, as shown in FIGS. 7-8, the housing 108 may include a processor 112 and a power source 116. The processor 112 may be coupled to each of the sensor(s) 102 and the speaker(s) 106. In a specific example, as shown in FIG. 7, the housing 108 may further include a power switch and a charging port. As shown in FIG. 6, the housing 108 may include features to enhance water resistance. For instance, the housing 108 may include O-rings and grommets to militate against water from penetrating the housing 108. Additionally, the housing 108 includes a hollow portion that allows for a certain volume of airspace. Desirably, the volume of airspace may allow the alert system 100 to float if the alert system 100 is unintentionally disposed in a pool and militate against the alert system 100 from sinking. Additionally, the buoyancy of the sensor panel 104 may also assist with militating against the system alert system 100 from sinking if it were unintentionally disposed in a pool.

In certain circumstances, the speaker 106 may be provided as a directional speaker. Advantageously, a directional speaker 106 may provide more efficient noise propagation. For instance, the directional speaker 106 may direct the notification sound in line with the lane of the intended user. The directional speaker 106 may also militate against the notification sound from traveling into unintended areas, such as a portion of the pool outside of the lane of the intended user.

In certain circumstances, the alert system 100 may also include a low-battery notification feature. For instance, the processor 112 may engage the speaker(s) 106 to emit an audible signal once the power source 116, such as a battery, is depleted below a predetermined threshold. In a specific example, the power source 116 may be a rechargeable battery which may advantageously enhance the portability of the alert system 100.

In certain circumstances, the alert system 100 may include pool-side fasteners. Pool-side fasteners may couple the housing 108 to the wall and/or edge of the pool. Desirably, pool-side fasteners may militate against the alert system 100 from unintentionally moving once positioned for use along the edge of a pool. In another specific example, the housing 108 and/or the track system 110 may include a way for the alert system 100 to grip the wall and/or edge of the pool. For instance, the housing 108 and/or the track system 110 may include a pad that enhances the traction of the alert system 100 on the wall and/or edge of the pool. More specifically, the pad may constructed from a material that militates against the alert system 100 from sliding, such as rubber. Alternatively or in addition to the material of the pad, the pad may include a shape that enhances traction, such as ridges and/or ribs. One skilled in the art may select other suitable ways for coupling the alert system 100 to the pool, within the scope of the present disclosure.

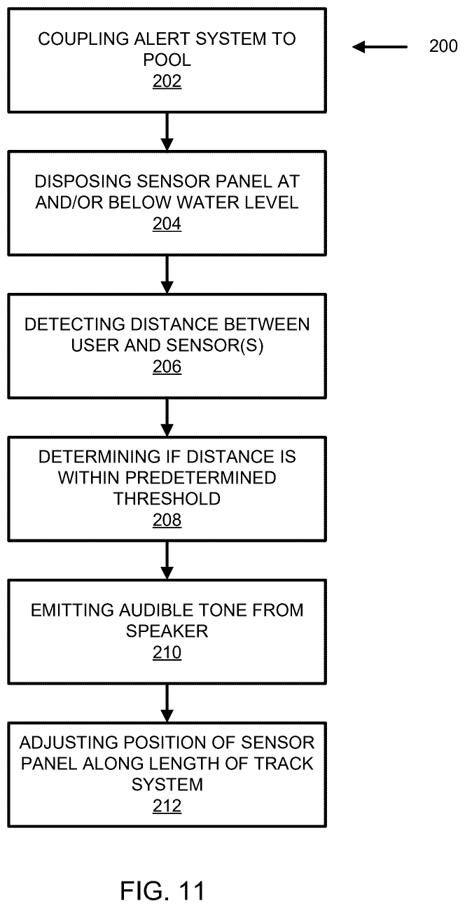

In certain circumstances, the alert system 100 of the present disclosure may be used in various ways. For instance, the alert system 100 may be used according to a method. As shown in FIG. 11, the method may include a step of coupling the alert system 100 to a wall and/or an edge of a pool. The sensor panel 104 may be disposed at and/or below the water level of the pool. Next, the method may include a step of detecting a distance between a user and the sensor(s) 102. Then, the method may include a step of determining if the distance is within a predetermined threshold from the sensor(s) 102. If the user is within the predetermined threshold, an audible alert may be emitted from the speaker(s) 106, thus notifying the user of their proximity to a wall of a pool. A skilled artisan may select other suitable ways of using the alert system 100 of the present disclosure, within the scope of the present disclosure.

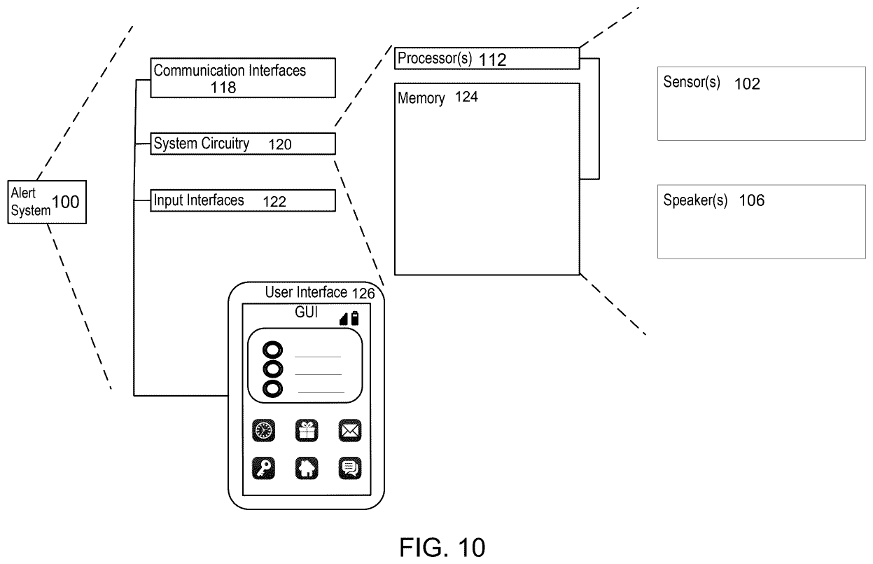

As shown in FIG. 10, the alert system 100 may further include a communication interface 118, a system circuitry 120, and/or an input interface 122. The system circuitry 120 may include the processor 112 or multiple processors. The processor 112 or multiple processors execute the steps to determine if a user is within a predetermined distance from the sensor(s) 102 and to emit an audible notification from the speaker(s) 106 once a user is determined to be within the predetermined distance from the sensor(s) 102. Alternatively, or in addition, the system circuitry 120 may include the memory 124.

The processor 112 may be in communication with the memory 124. In some examples, as shown in FIG. 10, the processor 112 may also be in communication with additional elements, such as the communication interface 118s, the input interface 122s, and/or a user interface 126. Examples of the processor 112 may include a general processor, a central processing unit, logical CPUs/arrays, a microcontroller, a server, an application specific integrated circuit (ASIC), a digital signal processor, a field programmable gate array (FPGA), and/or a digital circuit, analog circuit, or some combination thereof.

The processor 112 may be one or more devices operable to execute logic. The logic may include computer executable instructions or computer code stored in the memory 124 or in other memory that when executed by the processor 112, cause the processor 112 to perform the operations of the sensor(s) 102 and/or the speaker(s) 106. The computer code may include instructions executable with the processor 112. Provided as a non-limiting example, the processor 112 may also record a user's number of laps in a pool and/or their lap times.

The memory 124 may be any device for storing and retrieving data or any combination thereof. The memory 124 may include non-volatile and/or volatile memory, such as a random-access memory (RAM), a read-only memory (ROM), an erasable programmable read-only memory (EPROM), or flash memory. Alternatively or in addition, the memory 124 may include an optical, magnetic (hard-drive), solid-state drive, or any other form of data storage device. The memory 124 may be included in any component or sub-component of the system described herein.

The user interface 126 may include any interface for displaying graphical information. The system circuitry 120 and/or the communications interface(s) may communicate signals or commands to the user interface 126 that cause the user interface 126 to display graphical information. Alternatively, or in addition, the user interface 126 may be remote to the system and the system circuitry 120 and/or communication interface 118(s) may communicate instructions, such as HTML, to the user interface 126 to cause the user interface 126 to display, compile, and/or render information content. In some examples, the content displayed by the user interface 126 may be interactive or responsive to user input. For example, the user interface 126 may communicate signals, messages, and/or information back to the communications interface or system circuitry 120. In a specific example, the user interface 126 may enable a user to adjust the predetermined distance threshold so that the speaker 106 is engaged when the user is detected at either a closer distance or a farther distance from the sensor 102 than the default setting. Provided as a non-limiting example, the user interface 126 may display metrics of a user's performance, such as a user's number of laps in a pool and/or their lap times.

The system may be implemented in many different ways. In some examples, the system may be implemented with one or more logical components. For example, the logical components of the system may be hardware or a combination of hardware and software. In some examples, each logic component may include an application specific integrated circuit (ASIC), a Field Programmable Gate Array (FPGA), a digital logic circuit, an analog circuit, a combination of discrete circuits, gates, or any other type of hardware or combination thereof. Alternatively, or in addition, each component may include memory hardware, such as a portion of the memory 124, for example, that comprises instructions executable with the processor 112 or other processor to implement one or more of the features of the logical components. When any one of the logical components includes the portion of the memory 124 that comprises instructions executable with the processor 112, the component may or may not include the processor 112. In some examples, each logical component may just be the portion of the memory 124 or other physical memory that comprises instructions executable with the processor 112, or other processor(s), to implement the features of the corresponding component without the component including any other hardware. Because each component includes at least some hardware even when the included hardware comprises software, each component may be interchangeably referred to as a hardware component.

Some features are shown stored in a computer readable storage medium (for example, as logic implemented as computer executable instructions or as data structures in memory). All or part of the system and its logic and data structures may be stored on, distributed across, or read from one or more types of computer readable storage media. Examples of the computer readable storage medium/memory may include a hard disk, a flash drive, a cache, volatile memory, non-volatile memory, RAM, flash memory, or any other type of computer readable storage medium or storage media. The computer readable storage medium/memory 124 may include any type of non-transitory computer readable medium, such as a CD-ROM, a volatile memory, a non-volatile memory, ROM, RAM, or any other suitable storage device.

The processing capability of the system may be distributed among multiple entities, such as among multiple processor 112s and memories, optionally including multiple distributed processing systems. Parameters, databases, and other data structures may be separately stored and managed, may be incorporated into a single memory or database, may be logically and physically organized in many different ways, and may implemented with different types of data structures such as linked lists, hash tables, or implicit storage mechanisms. Logic, such as programs or circuitry, may be combined or split among multiple programs, distributed across several memories and processors, and may be implemented in a library, such as a shared library (for example, a dynamic link library (DLL).

All of the discussion, regardless of the particular implementation described, is illustrative in nature, rather than limiting. For example, although selected aspects, features, or components of the implementations are depicted as being stored in memory(s), all or part of the system or systems may be stored on, distributed across, or read from other computer readable storage media, for example, secondary storage devices such as hard disks and flash memory drives. Moreover, the various logical units, circuitry and screen display functionality is but one example of such functionality and any other configurations encompassing similar functionality are possible.

The respective logic, software or instructions for implementing the processes, methods and/or techniques discussed above may be provided on computer readable storage media. The functions, acts or tasks illustrated in the figures or described herein may be executed in response to one or more sets of logic or instructions stored in or on computer readable media. The functions, acts or tasks are independent of the particular type of instructions set, storage media, processor or processing strategy and may be performed by software, hardware, integrated circuits, firmware, micro code and the like, operating alone or in combination. Likewise, processing strategies may include multiprocessing, multitasking, parallel processing and the like. In one example, the instructions are stored on a removable media device for reading by local or remote systems. In other examples, the logic or instructions are stored in a remote location for transferring through a computer network or over telephone lines. In yet other examples, the logic or instructions are stored within a given computer and/or central processing unit (“CPU”).

Furthermore, although specific components are described above, methods, systems, and articles of manufacture described herein may include additional, fewer, or different components. For example, a processor 112 may be implemented as a microprocessor, microcontroller, application specific integrated circuit (ASIC), discrete logic, or a combination of other type of circuits or logic. Similarly, memories may be DRAM, SRAM, Flash or any other type of memory. Flags, data, databases, tables, entities, and other data structures may be separately stored and managed, may be incorporated into a single memory or database, may be distributed, or may be logically and physically organized in many different ways. The components may operate independently or be part of a same apparatus executing a same program or different programs. The components may be resident on separate hardware, such as separate removable circuit boards, or share common hardware, such as a same memory and processor for implementing instructions from the memory 124. Programs may be parts of a single program, separate programs, or distributed across several memories and processors.

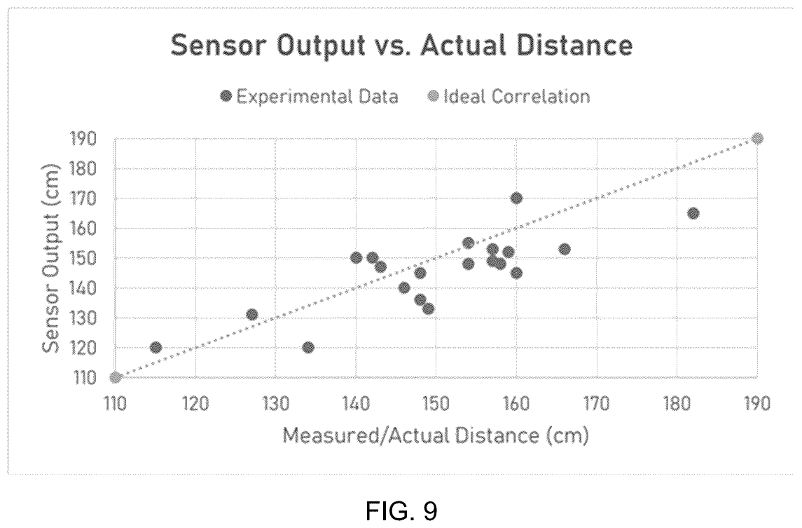

Provided as a non-limiting example, the alert system 100 exhibited promising results during experimental testing, as shown in FIG. 9. During these experimental trials, the alert system 100 had a sensing uncertainty of +/−4.5 cm (97% accuracy).

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions, and methods can be made within the scope of the present technology, with substantially similar results.

What is claimed is:

1. An alert system comprising:
a sensor panel;
a sensor coupled to the sensor panel;
a speaker coupled to the sensor panel; and
a housing coupled to the sensor panel, the housing having a processor coupled to at least one of the sensor and the speaker.

2. The system of claim 1, wherein the sensor panel has a density less than the density of water.

3. The system of claim 2, wherein the sensor is an ultrasonic sensor.

4. The system of claim 2, wherein the sensor includes a plurality of sensors.

5. The system of claim 2, wherein the speaker includes a plurality of speakers.

6. The system of claim 2, further comprising a track system coupling the sensor panel to the housing, where the sensor panel travels a length of the track system.

7. The system of claim 6, wherein the track system is moveable between a first position and a second position.

8. The system of claim 7, wherein the track system includes a hinge to move the track system between the first position and the second position.

9. The system of claim 4, wherein the plurality of speakers are spaced apart by at least around twelve inches.

10. The system of claim 3, wherein the housing includes a rechargeable power source.

11. The system of claim 6, wherein the sensor panel includes ethylene-vinyl acetate (EVA) foam providing buoyancy to maintain an alignment of the sensor with a waterline.

12. The system of claim 11, wherein the track system includes a t-slotted framing bar which enables vertical repositioning of the sensor panel relative to a pool wall.

13. The system of claim 6, wherein the speaker is a waterproof buzzer producing a tone when a user is within a detection range.

14. The system of claim 13, wherein the processor includes instructions to continuously acquire distance measurements from the ultrasonic sensor and activate the speaker when the measured distance is less than the detection range.

15. The system of claim 6, wherein the speaker is a directional speaker configured to produce a tone substantially confined to a single swimming lane.

16. The system of claim 10, wherein the processor includes a low-battery alert function to generate an audio warning via the speaker where a state of charge of the rechargeable power source falls below a predetermined threshold.

17. A method of using an alert system to notify a user of their proximity to an obstruction, the method comprising the steps of:
disposing a sensor panel to one of at and below a surface of water;
detecting a distance between the user and the sensor;
determining if the distance is within a predetermined threshold; and
emitting an audible tone from the speaker if the distance is determined within the predetermined threshold.

18. The method of claim 17, further comprising a step of adjusting the position of the sensor panel along a length of a track system that maintains an alignment between the sensor and the surface of the water.

19. The method of claim 17, wherein the step of disposing the sensor panel to one of at and below a surface of water includes coupling the sensor panel along an edge of a swimming pool.

20. The method of claim 19, wherein the step of coupling the sensor panel along the edge of the swimming pool includes utilizing pool-side fasteners.
